(19) United States
(12) Patent Application Publication
(10) Pub. No.: US 2006/0273897 A1
(43) Pub. Date: Dec. 7, 2006

(54) DYNAMIC SOFTWARE SYSTEM FOR A SECURITY CHECKPOINT

(76) Inventor: Alan RISI, Whitestone, NY (NY)

Correspondence Address: WILLIAM COLLARD;COLLARD & ROE, P.C., 1077 NORTHERN BOULEVARD, ROSLYN, NY, 11576, US

(21) Appl. No.: 11/421,708

(22) Filed: Jun. 1, 2006

Related U.S. Application Data
(60) Provisional application No. 60/687,643, filed on Jun. 3, 2005.

(51) Int. Cl. G08B 21/00

(52) U.S. Cl. 340/540; 340/666; 340/5.3

(57) ABSTRACT

A method for analyzing an object passing through a security checkpoint. The method can include analyzing a mass distribution the object to create a reading, analyzing a movement the object to create a reading, and analyzing a volume of the object to create a reading. These readings are then compared to a pre-set group of criteria. If this pre-set group of criteria is exceeded, an alarm is sounded. Alternatively, if this pre-set group of criteria is not exceeded, the alarm is not sounded. If the criteria is exceeded, a second door will remain closed and a first door will open allowing a user to leave a security enclosure.

### CROSS REFERENCE TO RELATED APPLICATIONS

Applicant claims priority under 35 U.S.C. §119e of Provisional Application Ser. No. 60/687,643 filed on Jun. 3, 2005, to Mr. Alan Risi and titled, “Dynamic Software System”, the disclosure of which is hereby incorporated herein by reference.

### BACKGROUND OF THE INVENTION

The invention relates to a dynamic software system which can be used to analyze the movement of an individual through a security checkpoint. There are other disclosures that relate to security checkpoints. For example, U.S. Pat. Nos. 6,724,304 to Risi filed on Aug. 28, 2003, and issued on Apr. 20, 2004, the disclosure of which is hereby incorporated herein in its entirety, and U.S. Pat. No. 6,472,984 to Risi filed on Jan. 30, 2001 and issued on Oct. 29, 2002 the disclosure of which is hereby incorporated herein by reference in its entirety.

In addition, ultrasonic sensors are known in the art, for example, U.S. Pat. Nos. 5,042,015 and 6,049,386 to Stringer et al the disclosures of which are hereby incorporated herein by reference.

### SUMMARY OF THE INVENTION

The invention can relate to a system for monitoring individuals through a security checkpoint comprising at least one mass sensor to detect a mass of an individual. There can also be at least one volume sensor to determine the volume of the individual and a plurality of sensors to determine a movement of the individual. There can also be a computer to receive information from the sensors and to record information from the sensors. There can also be a database to compare pre-recorded values for readings from the sensors to determine whether an individual may be violating or exceeding any one of the pre-recorded values. In this case, at least one mass sensor can be in the form of a load cell. There can also be at least one volume sensor is in the form of an ultrasonic sensor to determine the volume of an individual passing the securing checkpoint. In at least one embodiment, the movement sensor can be in the form of a radar which can track movement via an infrared beam. The device can also comprise a housing, wherein the housing encloses the sensors.

This housing can also further comprise a floor, wherein at least one mass sensor is disposed underneath the floor. This housing can also further comprise at least two doors wherein the doors can comprise a first door and a second door. The first door serves as an entrance and the second door can serve as an exit. This device can also further comprise a plurality of motors with at least one motor for opening the first door and the at least one motor for opening the second door. At least one embodiment can include an identity reader to determine an identity of an individual passing through the security checkpoint. There can also be a contraband detector, which can be used to detect contraband that would be excluded. This contraband detector can be in the form of a metal detector.

The invention can also relate to a method for analyzing an object passing through a security checkpoint. This method can also include the step of analyzing a mass distribution in the object to create a reading. The method can also include the step of analyzing a movement of an individual or object to create a reading. This process can also include the step of analyzing a volume of the object or individual to create a reading and then also comparing at least one of the readings based upon the mass distribution, the movement, and the volume with a set of criteria. This process can also include the step of sounding an alarm when differences between the reading and the set of criteria exceeds a predetermined threshold.

In addition, the process can also include the step of opening a door in response to a reading of at least one set of criteria.

In at least one embodiment, the step of opening a door includes opening a first door forming an entrance into a security checkpoint. This step of opening a door can include opening a second door which serves as an exit to the security checkpoint if the threshold is not exceeded.

In all, because at least three criteria are analyzed, this dynamic software system can accurately and automatically analyze whether a security standard has been breeched.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a side cross-sectional view of an enclosure;

FIG. 2 is a top view of an enclosure;

FIG. 3 is a block diagram of the schematic block layout of the computerized system for the enclosure;

FIG. 4 is a first embodiment of a process for analyzing users passing through the enclosure; and

FIG. 5 is a layout of a table for analyzing characteristics of an individual passing through a security checkpoint;

FIG. 6 is a second embodiment of a process for analyzing a user passing through the enclosure;

FIG. 7 is a chart showing an analysis of a mass distribution curve for determining how the mass is distributed onto a load cell; and

FIG. 8 is a layout of the table for reading the dynamic set of mass characteristics.

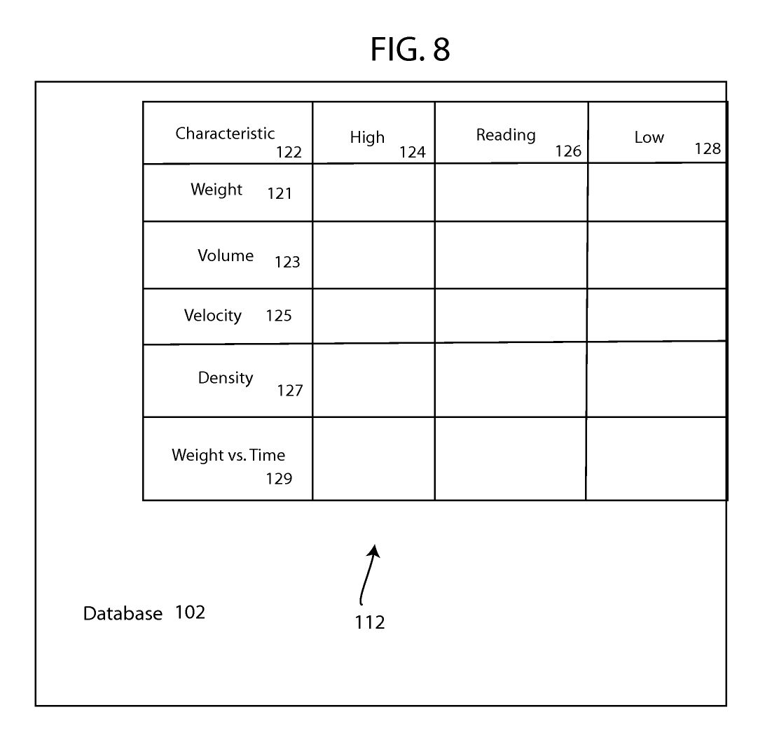

### DETAILED DESCRIPTION OF PREFERRED EMBODIMENTS

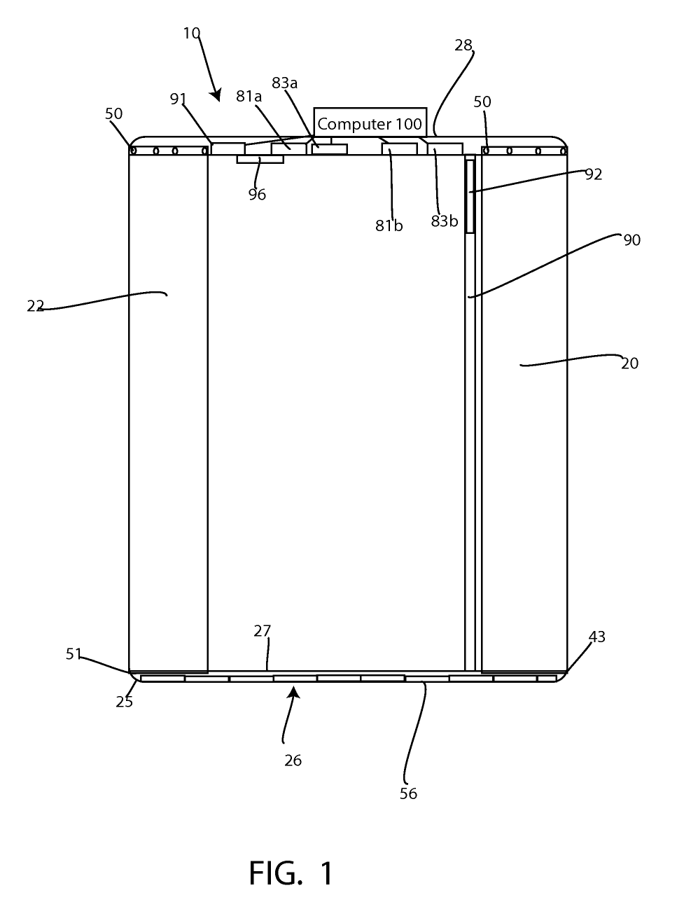

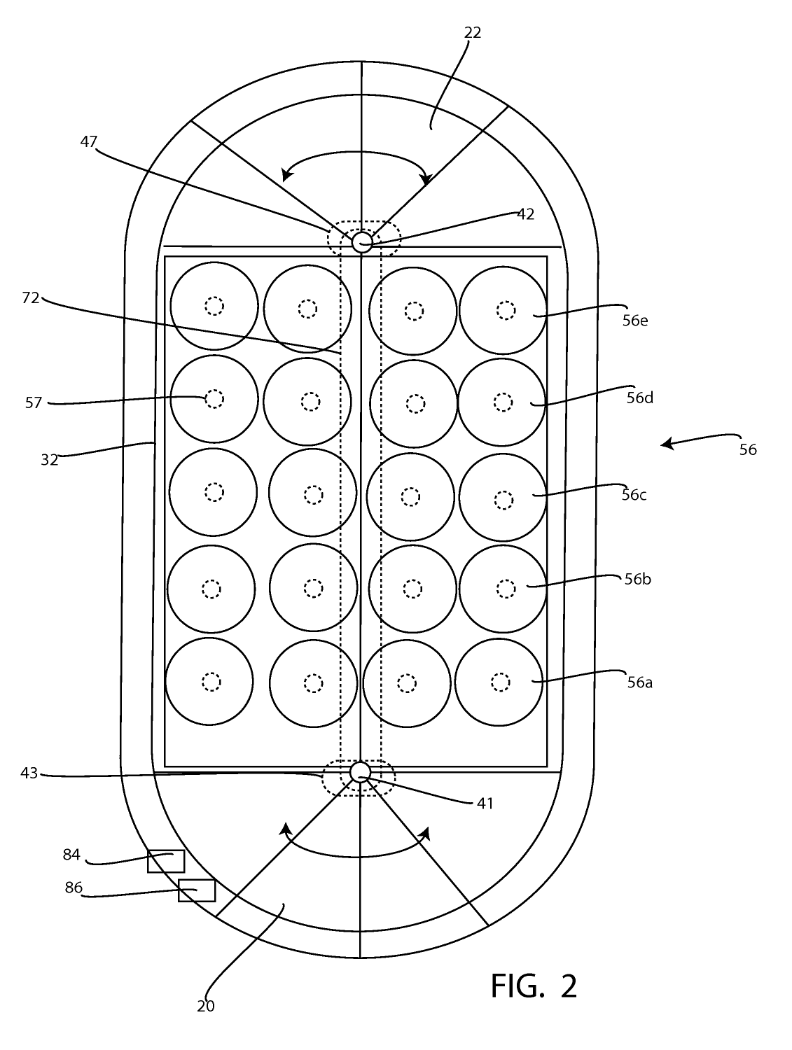

As shown in FIG. 1, a security system can include housing 10 having a bottom portion 12, top portion 14, and also side walls 18 for forming an outer frame. There is a first portal or door 20 at a first or infeed area portion and a second portal or door 22 (FIG. 2) at a second or protected area portion of the frame. Side walls 18 can be made from any known material and can extend between and be supported by pillars but do not block the portals. The side walls of the external structure can be formed from a transparent but strong material such as bullet resistant glass.

The system can also include a floor element 26 disposed at bottom portion 12, and a ceiling element 28 disposed at top portion 14. Floor element 26 can include a first layer 25 and a second layer 27. First layer 25 forms a base for the enclosure, while second layer 27 is in the form of a “false bottom” or flooring that rests above the first layer 25 on top of load cells 56. FIG. 2 shows a plan view of an example of an enclosure with this second layer 27 or floor removed. With this design, there can be at least one or a plurality of load cells 56 which can be used to read the mass of a user as the user is inside of the enclosure.

For example, there is shown a plurality of load cells 56 wherein the entire mass of individual(s) disposed inside of the enclosure is read. In addition, the movement and mannerisms of the individuals crossing the many different load cells 56 can be used to provide a reading or set of measurement characteristics for determining the type of individual or individuals crossing this enclosure.

The load cells are conventional mass-sensing elements arranged to detect the mass of an individual crossing a floor and anything disposed inside the chamber and to provide an electrical signal representing the mass. For example, the load cells may be of the strain-gauge type incorporating a resilient member such as a spring and a conventional strain-gauge arranged to detect the deformation of the spring. Other conventional types of load-sensing elements such as capacitive, magnetostrictive, hydraulic, and optical load-sensing elements may be used. The load cells can be arranged to provide a weighing range from an empty mass equal to the mass of the internal structure or flooring alone to a maximum mass equal to the mass of the internal structure or flooring plus a maximum load threshold, desirably about 300 Kg or more. The load cells are also arranged to provide sensitivity of about 170 g. or greater at least in the lower end of the weighing range, close to the empty mass.

Each of these load cells is formed with an identifying device such as an identifying chip 57. Thus, each of these load cells with its identity is logged through either controller 71 and/or computer 100. Because there can be many load cells each of these load cells can be given an address or a location within the housing. In this way, when a user steps on an individual cell, the mass that is registered on this cell is recorded and inserted based upon the simultaneous mass put on all of the cells.

In addition, the position and movement of the individual inside the enclosure can be traced based upon the identity of the load cells.

The first door 20 can be supported on the ceiling element by a pair of rollers 50. The lower edge of the door or portal 20 is also guided by a track in floor element 26 or other suitable guide elements (not shown). When the first door 20 is in the full closed position, it blocks the first opening in the housing 10.

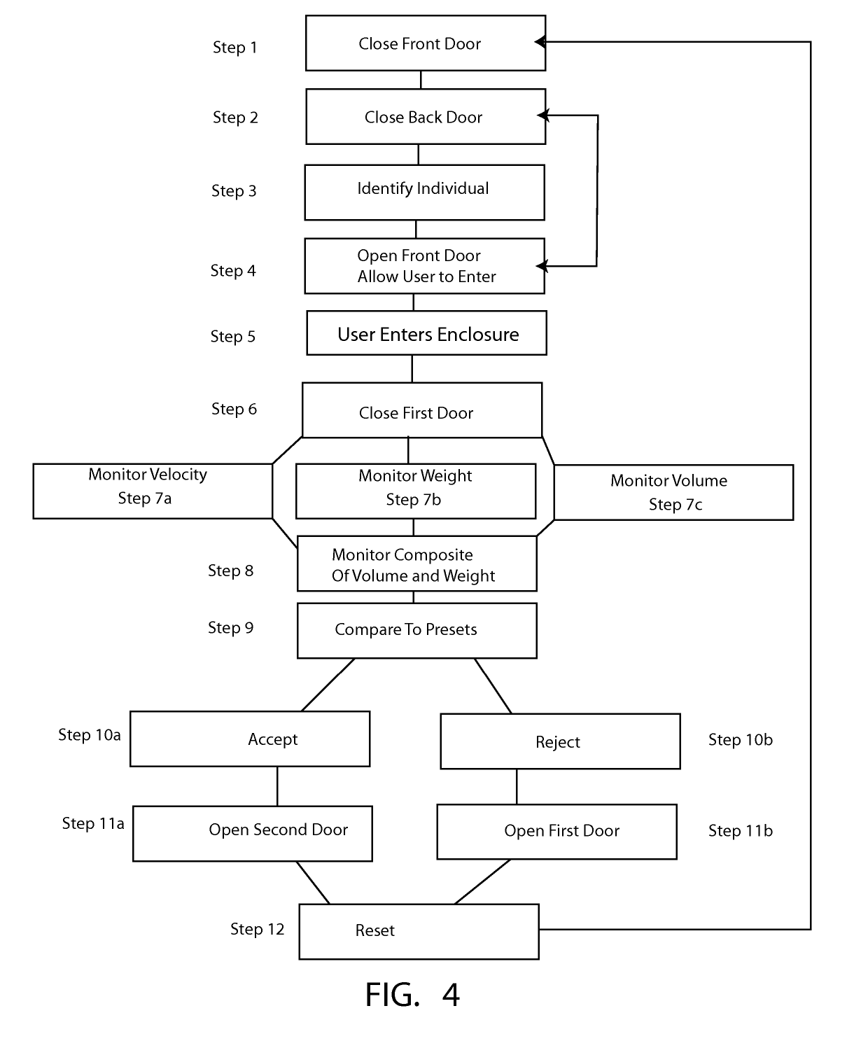

There can also be a second door 22 that is supported in the housing via rollers 50 and also guided at its lower end. Both doors are arranged for pivoting movement around a door pivot 41 and 42, so that the second door can move from the full closed position and the full open position (FIG. 4). When the second door 22 is in the full closed position it blocks the second opening of the housing.

When the first 20 and second 22 doors are in their fully closed positions, the internal structure defines an enclosed chamber bounded by the internal side walls 32 and by the doors 20, and 22.

A motor drive unit 72 (FIG. 2) is mounted within the top portion 14 of the external housing 10. The motor drive unit 72 is connected through linkage to each of the two doors. The motor drive unit 72 incorporates at least one motor, desirably a stepper motor and power transmission elements such as a gear train, a drive arm or the like. Preferably, the motor drive unit includes separate motors 43 and 47 associated with each door. Alternatively, the motor drive unit can include a single motor and clutches for selectively connecting the motor to any one of the doors.

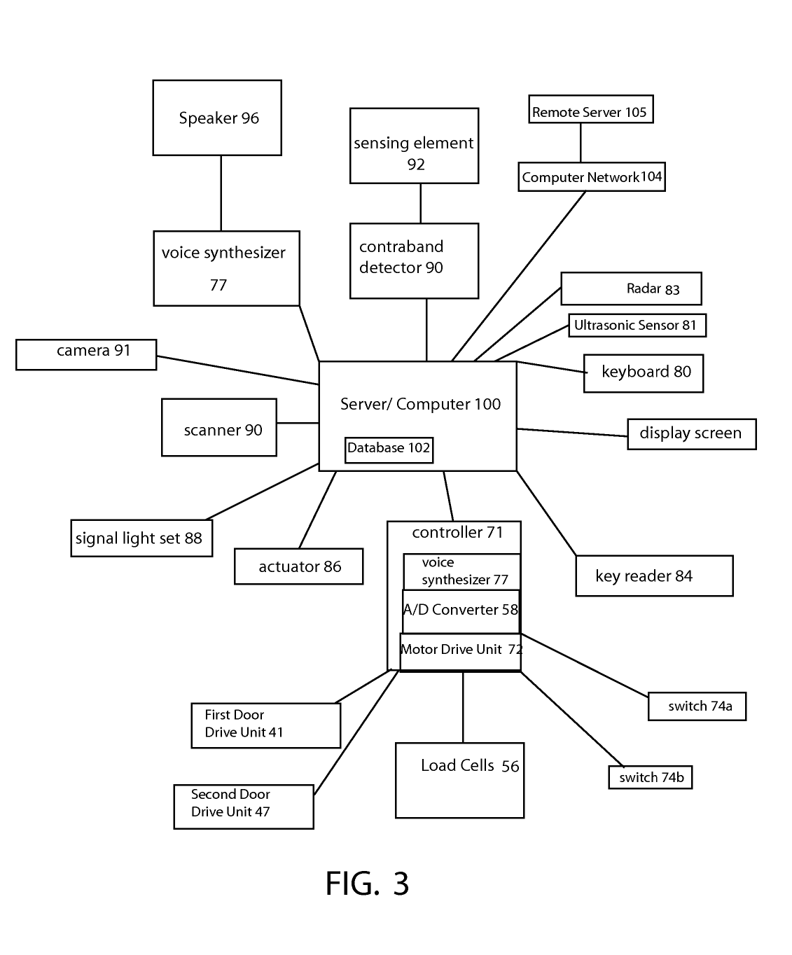

The system also includes a controller 71 (see also FIG. 3) incorporating a solid state microcontroller with associated storage elements such as an electronically erasable programmable read-only memory (“EEPROM”) (not shown). The controller also includes an appropriate analog circuit for detecting signals from load cells 56 and an internal analog to digital converter 58. The electrical circuit connected to the load cells desirably also includes field adjustable elements such as potentiometers for nulling the load cells to provide a predetermined signal at the empty weight or mass. The controller can also include the motor drive unit 72 for opening each of the doors and for detecting the positions of the doors as they move from full open to full closed position. This controller can be incorporated into computer 100 such that computer 100 performs all of the operations of controller 71 or, controller 71 can be separate from computer 100, wherein controller 71 simply relays instructions back and forth from computer 100.

Switches 74a and 74b connected to controller 71 are provided for detecting when each door is at its full open position or full closed position. A keypad 80 and display screen 82 are also linked to the controller 71. Controller 71 is connected to a battery (not shown) and to a main power supply such as an ordinary power plug for connection to conventional utility power. The controller includes a mains power failure sensor, which detects absence of normal power at the utility plug, and a low battery sensor, which detects a drop in the voltage from the battery.

The system can further include at least one key reader 84. The key reader can be arranged to read individual keys used by security personnel operating the system. Key readers 84 may be mechanically actuated key switches for conventional devices for reading electrically encoded keys. Where electrically or magnetically encoded keys are used, the controller may be arranged to memorize individual codes on particular keys as belonging to any of the various classes during a key acquisition or learning phase of operation.

The system can further include an actuator 86 and a signal light set 88 at each portal. The signal light set is arranged to provide a visible signal indicating to the user when he should proceed into the system as, for example, a green light for proceed and a red light for stop. In the embodiment illustrated, the actuator is simply a push button, which can be actuated by any person passing through the system. As further explained below, however, more complex actuators, such as biometric or numeric keypad devices may be used.

In addition, there can also be a plurality of detecting components such as an ultrasonic sensor or sensors 81a and 81b. There can also be at least one radar 83a or a plurality of radar detectors 83b. These components are either directly or indirectly in communication either in a wired manner or wirelessly with server or computer 100. This server or computer can be running on a Windows® or on a Linux® platform and wherein this device can be networked with other computers to communicate with a remote server or remote computer.

The system can also include a contraband detector 90 arranged to detect contraband at the infeed area portion of the system. The contraband detector may be a conventional electromagnetic or other metal detector having a set of sensing elements 92 disposed adjacent to a space 94 just outside of first door 20. The metal or contraband detector is arranged to provide an alarm signal to controller 71 if metal is detected passing through the detector space 94. One suitable type of metal detector is commercially available under the designation 2PN8HI from the CAA, S.p.A. of Viciomaggio (AZ), Italy.

The system can further optionally include a voice synthesizer 77 integrated in controller 71. The voice synthesizer is linked to a speaker 96 disposed within the chamber. An intercom (not shown) may also be provided for allowing communication between a person within the chamber and security personnel outside of the chamber.

Controller 71 or computer 100 can then optionally recheck the mass of the internal structure and chamber once again. If the mass of the internal structure and chamber is above the person-in-chamber threshold, indicating that a person still remains within the chamber, controller 71 actuates the first door once again, allowing the person who entered the enclosure to now leave. Before opening the second door, controller 71 may issue a voice command through the loud speaker instructing the person to proceed through the second door and into the protected area.

If the mass exceeds the maximum limit, the controller 71 does not open second door 22, but instead issues a command through speaker 96 (See FIG. 1) directing the person or persons within the chamber to exit the chamber through the first door, and holds the first door open. Typically, the mass of the chamber will exceed the maximum threshold if more than one person is in the chamber in a single cycle.

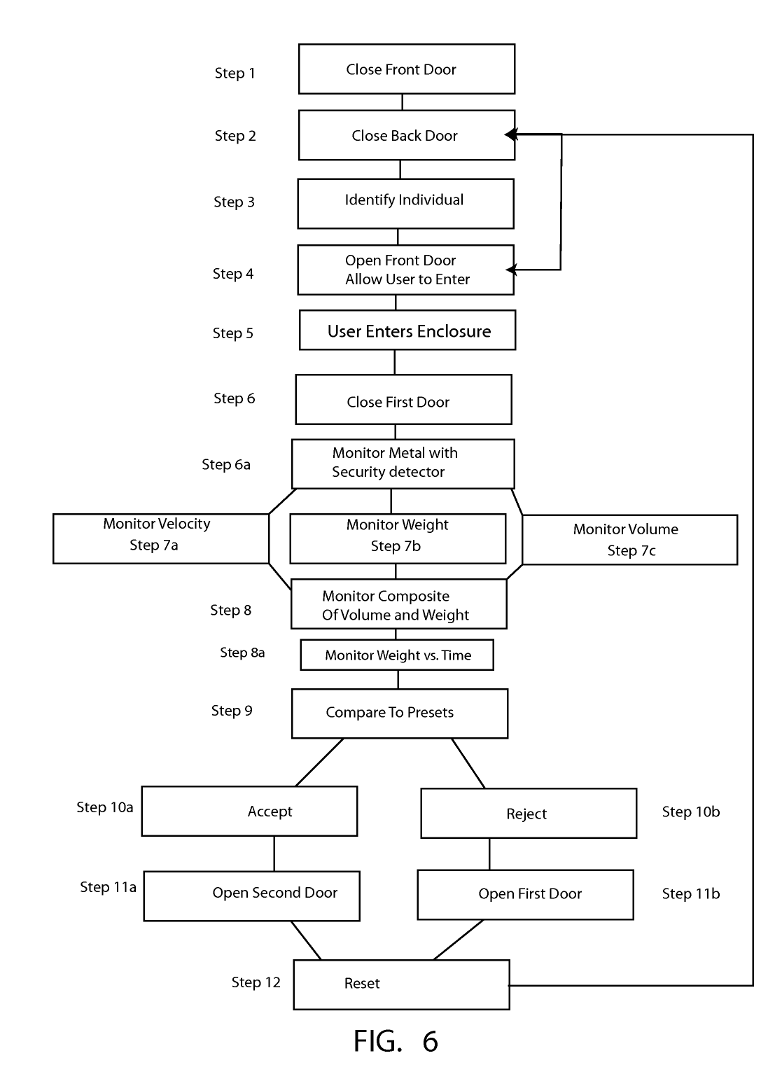

In addition with further analysis, if the volume exceeds or falls outside a pre-set limit, or if the radar detects a movement or a set of movements outside the pre-set limits, the controller 71 does not open the second door 22. Instead, computer 100 or controller 71 issues a command through speaker 96 directing the person or persons within a chamber to exit the chamber through the first door. The controller or computer 100 can then hold this first door open. The process for determining whether a person has exceeded the standards set for mass, movement or volume, are outlined in FIGS. 4 and 6.

Alternatively, if metal or security detector 90 issued an alarm signal, then the controller actuates the motor drive unit 72 to sound an alarm. When the controller is in this alarm condition, it can only be reset to resume further automatic operation by manual input from the keypad. Typically, this condition will occur if a person who triggered the metal detector seeks to defeat the system by leaving a gun or other contraband inside the chamber for someone to carry into the protected area in a subsequent cycle.

If the mass of the chamber is below the object in chamber threshold, the controller will clear the alarm signal set by the metal detector and begin a new cycle, whereupon a new person can be checked for contraband. Upon being manually checked for contraband, the original suspicious individual can be admitted directly to an alternate area if security personnel believe he is clean. However, if the manual search turns up contraband, the person can be detained.

If the mass of the chamber is above the mass of the object in chamber threshold, or if a foreign mass is detected, the controller again issues the object in chamber alarm and ceases automatic operation until manually reset by security personnel using the keyboard.

In a variant of the operating procedures discussed above, the system normally waits with the first, and second doors closed. The first door opens only when commanded to do so by an input through actuator 86.

For example, there can be a dynamic software system that works either with any known hardware or with the hardware listed above to identify and screen an individual through a security checkpoint.

For example, this process is shown by way of example in FIG. 4 wherein in step 1, computer 100 instructs controller 71 to close the first door using first door drive unit 41. In addition, either before, during or after this process, computer 100 could also instruct second door drive unit 47 to close the second or back door such as shown in step 2. In step 3, an individual could optionally identify himself or herself to the system. This identification step could occur by the user either inputting his or her security code into a keypad or key reader 84, or swiping a RFID card or key, or inserting an identity key or card to identify the user into actuator 86. Alternatively, biometric readers such as an eye scanner or a fingerprint scanner could be used to identify the individual through scanner 90 which is in communication with computer or server 100.

In a simpler system, a simple actuator 86 could be used wherein when a user presses an actuator, the first door will open, but only after determining that the second door is closed. Thus, step 4 which includes opening a front door will only proceed if the second or back door is first closed.

In step 5 a user can enter the enclosure. The system can recognize that the user has entered the enclosure by reading that mass has been pressed down on load cells 56, or recognized by the ultrasonic sensors 81 or the radar 83 or the multiple ultrasonic sensors 81a and 81b or multiple radar sensors 83a and 83b. Once the system recognizes that the user has entered the enclosure, computer 100 instructs controller 71, to drive motor drive unit 72 to instruct first door drive unit 41 to close the first door 20. This creates an enclosed security area for an individual user.

At this point, the system monitors three key components, the velocity of the individual(s) across a platform or a floor, the mass or the mass distribution of the individual(s) on the floor and the volume of the individual(s) in the enclosure. In one embodiment, when an individual presses on a first load cell in the enclosure, this signal triggers the ultrasonic sensor(s) and the radar(s) to start their analysis. In another optional embodiment, these sensor(s) and radar(s) could start when the door opens, or when instructed by a user.

In addition, a composite reading can be created wherein the system could categorize or process the density of the user based upon the mass reading and the volumetric reading of that individual.

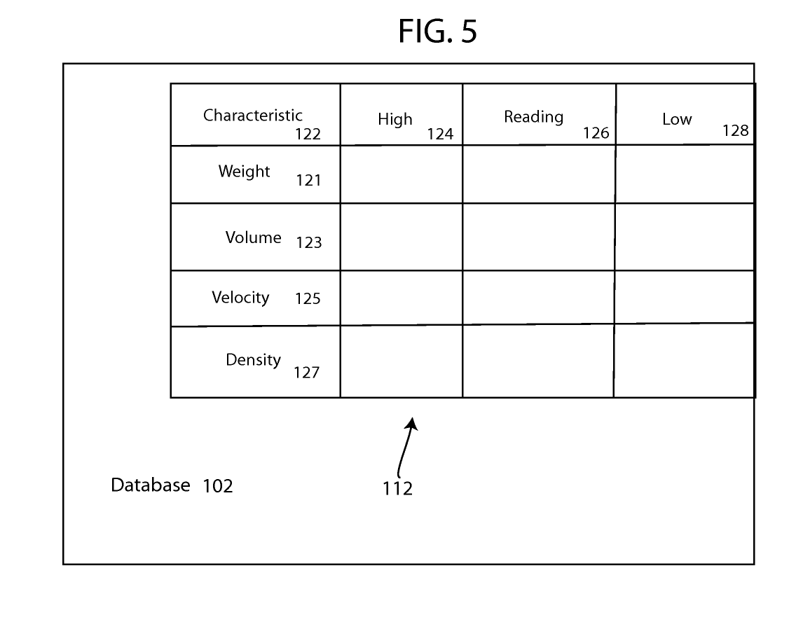

FIG. 5 shows a table 112 that is associated with database 102. This table includes the different parameters for analyzing an individual passing through a security checkpoint or enclosure. For example table 112 includes headings for characteristics 122 which can include mass 121, volume 125, velocity 127 and density 129. The readings 126 for each of these characteristics can be recorded and compared against the parameters such as the allowed high 124 and low 128 parameters for each of these characteristics.

All of the preset characteristics could be stored in a database 102, either stored in a mass storage device such as a hard drive in computer 100 or in a remote server or computer 105 which can be contacted via a computer network 104.

For example, if the total mass reading was above the set of parameters, then the system may initiate a failure and reject the participant. Alternatively, if the reading on the different load cells 56 is one that would indicate that two users are inside of the enclosure, the system could reject the individual(s). For example, if three non-adjacent load cells are loaded, then the system would fail. This is type of a result would indicate that at least two users would be inside of the enclosure at the same time. This type of condition would be unacceptable to an individual security checkpoint.

Another example of a failure indicator would be if the user proceeded too rapidly through the security checkpoint. In this case the radar 83 would indicate an advanced movement that is too quick through the checkpoint.

Another example of a failure indicator would be if the user moved forward and backward or side to side in a non-directed manner indicating that the individual inside of the security enclosure was being attacked or was in some form of abnormal condition. This condition could be identified by identifying the foot progression along each of the load cells 56. If the progression is irregular, such as with numerous side stepping or stepping back, and alarm will sound.

Another example of a failure indicator is if an individual entering the enclosure was moving too slowly indicating that the user may be carrying something or moving at a pace that would raise suspicion.

Another example of a failure situation is if the reading on the individual entering the enclosure was for an irregular shaped individual. This reading is performed using the ultrasonic sensors 81. The sensor would register a reading and then forward the results of this reading to computer 100. Computer 100 would then compare this reading to the reading stored in database 102. For example, the system could recognize that the object entering the enclosure was larger than a standard range for users entering in this enclosure. Alternatively, if the object or the user was smaller than the normal testing limit, the failure situation could be achieved as well.

Another example of a failure situation could be based upon a reading of the density of an individual. For example, the average density of the human body is approximately similar to that of water since the human body barely floats or sinks in water. In one estimate, the average density of a human body is 985 kg/m³, while the density of water is 1000 kg/m³. In contrast the average density of lead is 11340 kg/m³ which is over ten times the density of the human body. Therefore, if an individual were trying to smuggle a large pipe bomb through an enclosure, underneath the user's shirt, then this irregular density reading could be read and then forwarded to server/computer 100 for comparison to the allowed range. If the reading was outside of the proscribed range, then the system would reject the individual.

FIG. 6 shows an alternative flow chart which includes the monitoring of metals or other potentially harmful items along with the monitoring of the main characteristics of mass, volume, velocity and density. This process can include the additional step 6a which involves monitoring an individual and more particularly a particular sized metal object which can be performed using security detector 90. Thus, in this case, if a metal object that is larger than a particular size for which security detector 90 is set, then an alarm will sound and computer 100 will instruct the individual to leave the security chamber back through the first door 20.

In addition FIG. 6 also shows that the mass of an individual passing through this security checkpoint can be monitored using a dynamic plotting of the mass readings in this enclosure.

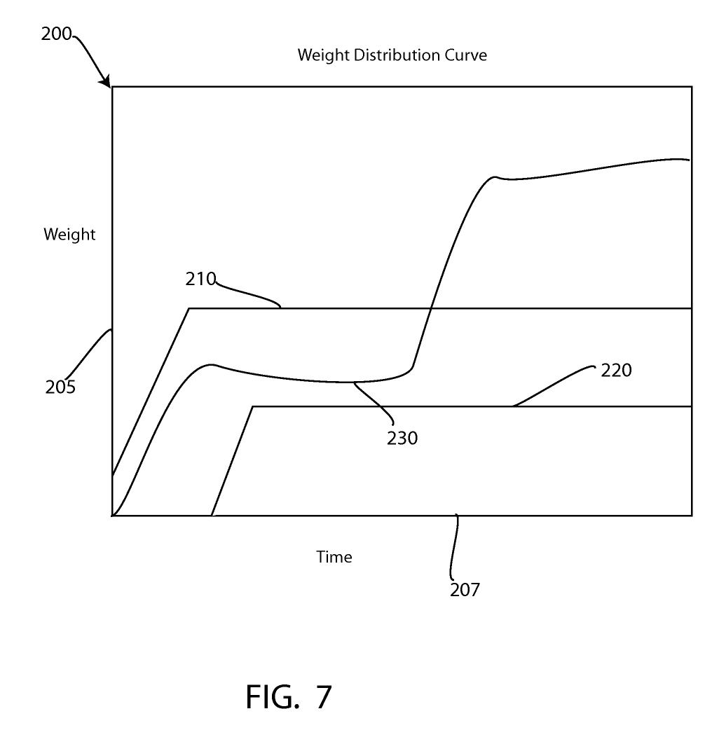

For example, FIG. 7 shows that the mass of an individual passing through a security checkpoint can be monitored dynamically. In this case, there is shown a graph 200 showing a reading 230 of a load placed on load cells 56 vs. time. This graph includes a plotting of the mass vs. the time on respective axes with vertical axis 205 representing the mass of an individual to be monitored while horizontal axis 207 represets the plot of the mass vs. time. In addition, lines 210 and 220 represent the acceptable parameters for an individual crossing through a security checkpoint. In this case, line 230 represents a reading of a failure or alarm situation. In this case the curve represents an approximation of a first individual entering into an enclosure, followed by a for example a second individual. In this case, there would be a spike in the additional mass before the first user has left the chamber. Alternatively, this spike in mass could occur if a single individual was carrying or dragging an inanimate object separate from the individual which would result in an additional irregular spike. Thus, for two individuals to “beat” this analysis, a first individual would have to be carrying a second individual through the security checkpoint, or both individuals would have to step into the checkpoint at the same time.

Thus, with this system, by analyzing numerous different characteristics on an individual, the system can effectively screen out potential security risks.

Accordingly, while a few embodiments of the present invention have been shown and described, it is to be understood that many changes and modifications may be made thereunto without departing from the spirit and scope of the invention as defined in the appended claims.

What is claimed is:

1. A system for monitoring individuals through a security checkpoint comprising:
a) at least one mass sensor to detect a mass of an individual;
b) at least one volume sensor to determine the volume of said individual;
c) a plurality of sensors to determine a movement of said individual;
d) a computer to receive information from said sensors and to record information from said sensors; and
e) a database to compare pre-recorded values for readings from said sensors to determine whether an individual may be violating any one of the pre-recorded values.

2. The system as in claim 1, wherein said at least one mass sensor is in the form of a load cell.

3. The system as in claim 1, wherein said at least one volume sensor is in the form of an ultrasonic sensor for determining the volume of an individual passing the securing checkpoint.

4. The system as in claim 1, wherein said at least one movement sensor is in the form of a radar.

5. The system as in claim 1, further comprising a housing, wherein said housing encloses said plurality of sensors.

6. The system as in claim 5, further comprising a floor, wherein said at least one mass sensor is disposed underneath said floor.

7. The system as in claim 5, further comprising at least two doors.

8. The system as in claim 7, wherein said at least two doors comprise a first door and a second door, wherein said first door serves as an entrance and said second door serves as an exit.

9. The system as in claim 8, further comprising a plurality of motors with at least a first motor for opening said first door and at least a second motor for opening said second door.

10. The system as in claim 1, further comprising an identity reader to determine an identity of an individual passing through said security checkpoint.

11. The system as in claim 1, further comprising a contraband detector, which can be used to detect contraband that would be excluded.

12. A method for analyzing an object passing through a security checkpoint comprising:
a) analyzing a mass distribution of the object to create a reading;
b) analyzing a movement of the object to create a reading;
c) analyzing a volume of the object to create a reading;
d) comparing at least one of said readings based upon said mass distribution, said movement, and said volume with a set of criteria;
e) sounding an alarm when differences between said at least one reading and said set of criteria exceeds a predetermined threshold.

13. The method as in claim 12, further comprising the step of opening a door in response to a reading of at least one set of criteria.

14. The method as in claim 13, wherein said step of opening a door includes opening a first door forming an entrance into a security checkpoint.

15. The method as in claim 13, wherein said step of opening a door includes opening a second door which serves as an exit to the security checkpoint if said threshold is not exceeded.

16. The method as in claim 12, further comprising the step of analyzing a mass distribution of the object vs. a period of time to create a reading.
